(19) United States
(12) Patent Application Publication
(10) Pub. No.: US 2022/0261106 A1
(43) Pub. Date: Aug. 18, 2022

(54) DISPLAY DEVICE

(71) Applicant: InnoLux Corporation, Miao-Li County (TW)

(72) Inventors: Jui-Jen YUEH, Miao-Li County (TW); Tsung-Han TSAI, Miao-Li County (TW); Kuan-Feng LEE, Miao-Li County (TW)

(73) Assignee: InnoLux Corporation, Miao-Li County (TW)

(21) Appl. No.: 17/577,395

(22) Filed: Jan. 18, 2022

(30) Foreign Application Priority Data
Feb. 18, 2021 (CN) 202110187690.6

(51) Int. Cl. G06F 3/041; G06F 3/044

(52) U.S. Cl. CPC G06F 3/0412; G06F 2203/04112; G06F 3/0446

(57) ABSTRACT

A display device includes a display layer, a touch sensor, an insulating layer and a collimator. The touch sensor is disposed on the display layer, the insulating layer is disposed on the touch sensor and the display layer, and the collimator is disposed on the insulating layer.

### BACKGROUND OF THE DISCLOSURE

### 1. Field of the Disclosure

The present disclosure relates to a display device, and more particularly to a display device with a privacy function or controllable viewing angle.

### 2. Description of the Prior Art

In recent years, display devices are widely applied in various electronic products, such as smart phones, tablets, notebook computers, televisions or vehicle displays. With the vigorous development of electronic products, display devices have become more and more important, so that manufacturers still keep on researching and developing for new display devices, and have higher expectations for more diversified functions of products.

### SUMMARY OF THE DISCLOSURE

One of objectives of the present disclosure is to provide a display device, which includes a display layer, a collimator, an insulating layer and a touch sensor, and privacy function and/or controllable viewing angle function may be integrated in the display device with touch function.

An embodiment of the present disclosure provides a display device. The display device includes a display layer, a touch sensor, an insulating layer and a collimator. The touch sensor is disposed on the display layer, the insulating layer is disposed on the touch sensor and the display layer, and the collimator is disposed on the insulating layer.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1A is a partial top-view schematic diagram of a display device of a first embodiment according to the present disclosure.

FIG. 1B is a cross-sectional view schematic diagram of the display device shown in FIG. 1A along the cross line A-A′.

FIG. 2 is a partial top-view schematic diagram of a touch sensor of a display device according to the present disclosure.

FIG. 3 is a cross-sectional view schematic diagram of a display device of a variation embodiment of the first embodiment according to the present disclosure.

FIG. 4 is a cross-sectional view schematic diagram of a display device of another variation embodiment of the first embodiment according to the present disclosure.

FIG. 5A is a partial top-view schematic diagram of a display device of a second embodiment according to the present disclosure.

FIG. 5B is a cross-sectional view schematic diagram of the display device shown in FIG. 5A along the cross line A-A′.

FIG. 6A is a partial top-view schematic diagram of a display device of a third embodiment according to the present disclosure.

FIG. 6B is a cross-sectional view schematic diagram of the display device shown in FIG. 6A along the cross line A-A′.

### DETAILED DESCRIPTION

The present disclosure may be understood by reference to the following detailed description, taken in conjunction with the drawings as described below. It is noted that, for purposes of illustrative clarity and being easily understood by the readers, various drawings of the present disclosure show a portion of the device or the structure, and certain elements in various drawings may not be drawn to scale. In addition, the number and dimension of each element shown in drawings are only illustrative and are not intended to limit the scope of the present disclosure.

Certain terms are used throughout the description and following claims to refer to particular components. As one skilled in the art will understand, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. When the terms “include”, “comprise” and/or “have” are used in the description of the present disclosure, the corresponding features, regions, steps, operations and/or components would be pointed to existence, but not limited to the existence or addition of one or more corresponding features, regions, steps, operations, components and/or combinations thereof. When a component or layer is referred to as being “on” or “connected to” another component or layer, it may be directly on or directly connected to the other component or layer, or intervening components or layers may be presented (indirect condition). In contrast, when a component or layer is referred to as being “directly on” or “directly connected to” another component or layer, there are no intervening components or layers presented.

In addition, the terms “bottom”, “below”, “above” and “top” are used to describe relative positions of different constituent elements in the drawings. However, when the drawings are turned upside down, the term “above” described above should be considered as presenting the meaning of “below”. It should be understood that spatial relative terms are intended to cover different directions of equipment in use or operation in addition to the directions shown in the drawings.

In the present disclosure, the thickness, length and width may be measured by using an optical microscope, and the thickness or length may be measured by a sectional image in an electron microscope, but not limited herein.

The terms “equal to” or “substantially” mentioned in this document generally mean being within 20% of a given value or range, or being within 10%, 5%, 3%, 2%, 1% or 0.5% of a given value or range.

Although terms such as first, second, third, etc., may be used to describe diverse constituent elements, such constituent elements are not limited by the terms. The terms are used only to discriminate a constituent element from other constituent elements in the specification. The claims may not use the same terms, but instead may use the terms first, second, third, etc. with respect to the order in which an element is claimed. Accordingly, in the following description, a first constituent element may be a second constituent element in a claim.

The electronic device may achieve display effects through the structures of the embodiments according to the present disclosure. The electronic device a display device, a sensor device, a tiled device or a transparent display device, but not limited herein. The electronic device may be rollable, stretchable, bendable or flexible electronic device. The electronic device may, for example, include liquid crystal, light-emitting diodes (LEDs), quantum dots (QDs), fluorescence or phosphors. The light-emitting diodes may, for example, include organic light-emitting diodes (OLEDs), mini-light-emitting diodes (mini LEDs), micro-light-emitting diodes (micro-LEDs) or quantum dot light-emitting diodes (e.g. QDLEDs), but not limited herein. The tiled device may be a display tiled device, but not limited herein. It should be noted that, the electronic device may be any combination of the devices described above, but not limited herein. In addition, the appearance of the electronic device may be rectangular, circular, polygonal, a shape with curved edges or other suitable shapes. The electronic device may have external systems such as a driving system, a control system, a light source system, a shelf system, etc. to support a display device or tiled device. In the following, a display device will be used to illustrate the contents of the present disclosure, but the present disclosure is not limited herein.

It should be noted that the technical features in different embodiments described in the following can be replaced, recombined, or mixed with one another to constitute another embodiment without departing from the spirit of the present disclosure.

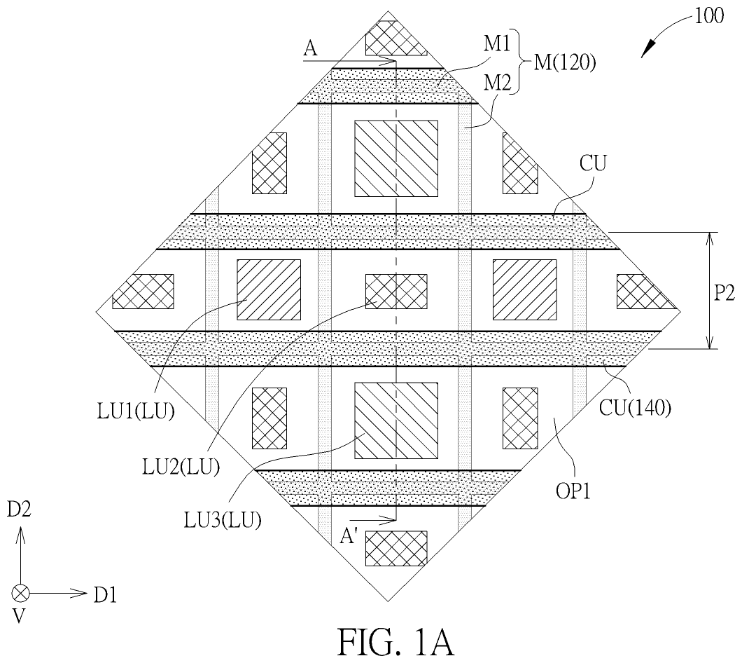

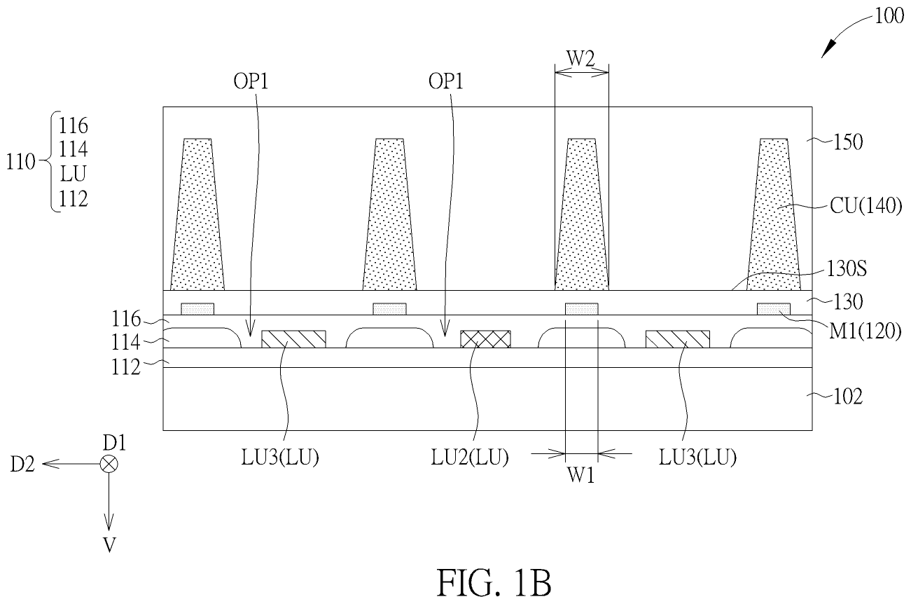

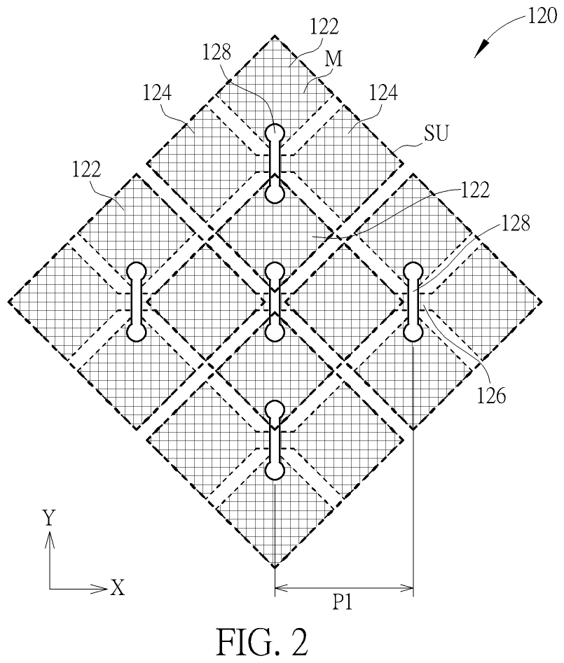

Please refer to FIG. 1A, FIG. 1B and FIG. 2. FIG. 1A is a partial top-view schematic diagram of a display device of a first embodiment according to the present disclosure. FIG. 1B is a cross-sectional view schematic diagram of the display device shown in FIG. 1A along the cross line A-A′. FIG. 2 is a partial top-view schematic diagram of a touch sensor of a display device according to the present disclosure. As shown in FIG. 1A, FIG. 1B and FIG. 2, the display device 100 of the present disclosure may include a display layer 110, a touch sensor 120, an insulating layer 130 and a collimator 140. The touch sensor 120 is disposed on the display layer 110, the insulating layer 130 is disposed on the touch sensor 120 and the display layer 110, and the collimator 140 is disposed on the insulating layer 130. The display device 100 may be, for example, a large-sized display device, such as a display applied in a vehicle (e.g., a dashboard, etc.). For example, the display device 100 may be a display device extending from a side of the driver's seat to a side of the passenger seat, but not limited herein.

The display layer 110 may be disposed on a substrate 102 when the display device 100 includes a light emitting unit (such as a light-emitting diode, LED), and the substrate 102 may, for example, include a hard substrate or a flexible substrate. The hard substrate may include, for example, glass, quartz, ceramic, sapphire, other suitable materials or combinations of the above materials, but not limited herein. The flexible substrate may, for example, include polyimide (PI), polyethylene terephthalate (PET), other suitable materials or combinations of the above materials, but not limited herein. The display layer 110 may include a circuit layer 112, a pixel definition layer (PDL) 114, a plurality of light emitting units LU and a protective layer 116, but not limited herein. The pixel definition layer 114 and the plurality of light emitting units LU may be disposed on the circuit layer 112. The pixel definition layer 114 includes a plurality of first openings OP1, and at least one light emitting unit LU may be correspondingly disposed in one of the plurality of first openings OP1 respectively, that is to say, the light emitting units LU may be, for example, correspondingly disposed in the first openings OP1 one-to-one, wherein one light emitting units LU is disposed correspondingly in one opening, but not limited herein. The plurality of light emitting units LU may, for example, include a first light emitting unit LU1, a second light emitting unit LU2 and/or a third light emitting unit LU3 to emit red light, green light and/or blue light respectively, but not limited herein. The first light emitting unit LU1, the second light emitting unit LU2 and the third light emitting unit LU3 may further have different sizes according to the light emitting efficiency thereof, but not limited herein. The light emitting unit LU may be electrically connected to the circuit layer 112 to emit light, but not limited herein. The protective layer 116 may cover the pixel definition layer 114 and the plurality of light emitting units LU, and may protect the pixel definition layer 114 and/or the plurality of light emitting units LU. The protective layer 116 may have a relatively flat surface. The protective layer 116 may be formed of, for example, organic material(s) or inorganic material(s). The organic materials may, for example, include polycarbonate, polyimide, acrylate or other suitable materials, but not limited herein. The inorganic materials may, for example, include silicon oxide (SiOx), silicon nitride (SiNx), silicon oxynitride (SiOxNy) or other suitable materials, but not limited herein. In addition, the protective layer 116 may also be a multilayer structure with a combination of inorganic material(s) and organic material(s), but not limited herein.

The touch sensor 120 may include conductive materials, such as being made of metal materials or transparent conductive materials. The touch sensor 120 may include at least one driving electrode 122 and at least one sensing electrode 124, and the sensing electrode 124 is electrically insulated from the driving electrode 122. For example, as shown in FIG. 2, the touch sensor 120 may include a plurality of driving electrodes 122 and a plurality of sensing electrodes 124 arranged alternately, the sensing electrodes 124 adjacent to each other in a direction X may be electrically connected to each other to form a plurality of sensing electrode series extending along the direction X, and the driving electrodes 122 adjacent to each other in a direction Y may be electrically connected to each other to form a plurality of driving electrode series extending along the direction Y, wherein the direction X may be, for example, substantially perpendicular to the direction Y, but not limited herein. The sensing electrode 124 and the driving electrode 122 may be formed of the same conductive material, but not limited herein. Two adjacent sensing electrodes 124 in the same sensing electrode series may be, for example, electrically connected by a conductive bridge 126. The conductive bridge 126 and the sensing electrodes 124 may be, for example, formed of the same material, and the conductive bridge 126 and the sensing electrodes 124 may be substantially located on the same plane. Relatively, two adjacent driving electrodes 122 in the same driving electrode series may be, for example, electrically connected by a conductive bridge 128. The conductive bridge 128 and the driving electrodes 122 may be formed of different materials, and the conductive bridge 128 and the driving electrodes 122 may be substantially located on different planes, but not limited herein. The conductive bridge 128 is partially overlapped with the conductive bridge 126, and an insulating material is disposed between the conductive bridge 126 and the conductive bridge 128 for electrical isolation, so that each electrode series may be connected in series, and the driving electrode series and the sensing electrode series may be electrically insulated from each other without producing short circuit, but not limited herein. A sensing unit SU may be formed by the plurality of driving electrodes 122 and the plurality of sensing electrodes 124, and the touch sensor 120 may include a plurality of sensing units SU, so as to sense whether the display device 100 is touched by an object, or the sending may still be performed even if the display device 100 is not touched by an object (e.g., floating touch). For example, a sensing unit SU may be formed when two adjacent driving electrodes 122 and two adjacent sensing electrodes 124 are intersected with each other, and five sensing units SU are shown in FIG. 2, but the number of driving electrodes 122 and sensing electrodes 124 forming the sensing unit SU and the number of the sensing units SU included in the touch sensor 120 are not limited herein, and may be adjusted according to practical requirements. In some embodiments, the touch sensor 120 may include at least two sensing units SU arranged in a first pitch P1. The first pitch P1 may be measured as the shortest distance from the center of one of the sensing units SU to the center of another adjacent sensing unit SU in the direction X, the shortest distance from the center line of the conductive bridge 128 in one of the sensing units SU to the center line of the conductive bridge 128 in another adjacent sensing unit SU in the direction X, or the shortest distance from one side of the conductive bridge 128 of one of the sensing units SU (e.g., the right side of this conductive bridge 128) to the same side of the conductive bridge 128 of another adjacent sensing unit SU (e.g., the right side of this another conductive bridge 128), but not limited herein. Although the first pitch P1 is measured in the direction X in this condition, the first pitch P1 between two adjacent sensing units SU may also be measured in the direction Y in the methods described above.

In some embodiments, each driving electrode 122 and/or each sensing electrode 124 of the touch sensor 120 may include a mesh structure M, that is, the mesh structure M shown in FIG. 1A may correspond to the mesh structure of one of the driving electrodes 122 or one of the sensing electrodes 124 of the touch sensor 120 shown in FIG. 2. In FIG. 1A, the mesh structure M of the driving electrode 122 is used as an example, but not limited herein. The mesh structure M may include a plurality of first mesh wires M1 and a plurality of second mesh wires M2, and the first mesh wires M1 and the second mesh wires M2 may extend along different directions and intersect to form the mesh structure M. For example, as shown in FIG. 1A, each first mesh wire M1 may extend along a first direction D1, and each second mesh wire M2 may extend along a second direction D2. The first direction D1 is different from the second direction D2, such as that the first direction D1 may be substantially perpendicular to the second direction D2, but not limited herein. In some embodiments, the mesh structure M is disposed corresponding to the pixel definition layer 114, so that the mesh structure M is not overlapped with the light emitting units LU in a normal direction V of the substrate 102. The mesh structure M is, for example, a metal mesh structure including metal materials, but not limited herein.

The insulating layer 130 may be made of an organic material. The organic material may include, for example, poly(methyl methacrylate) (PMMA), epoxy, polycarbonate or other suitable materials. The collimator 140 may, for example, include organic materials or organic-inorganic hybrid materials formed by mixing organic materials with inorganic materials, such as including white organic materials or white organic-inorganic hybrid materials with good light reflectivity, black organic materials or black organic-inorganic hybrid materials with good light absorption, or gray organic materials or gray organic-inorganic hybrid materials with both light reflectivity and light absorption. In some embodiments, the collimator 140 and the insulating layer 130 may include the same organic material, but not limited herein. The collimator 140 of the present disclosure may have a height in the normal direction V of the substrate 102 to adjust the light emitting angle of the light emitted by the light emitting unit LU, so that the emitted light may substantially direct to a direction or advance within a certain range of angle, which enables the light emitted by the display device 100 to have a narrower range of viewing angle.

In the present disclosure, the touch sensor 120 is disposed on the display layer 110. In detail, the touch sensor 120 is located between the display layer 110 and the collimator 140, that is, the touch sensor 120 is formed first and then the collimator 140 is formed. This design may make the process of the touch sensor 120 easier. In addition, the design that the touch sensor 120 is closer to the display layer 110 may facilitate the electrical connection of the touch sensor 120 to the circuit in the display layer 110 or other circuits on the substrate 102. Furthermore, the insulating layer 130 is disposed on the touch sensor 120 and the display layer 110, and the collimator 140 is disposed on the insulating layer 130, that is, the insulating layer 130 is located between the touch sensor 120 and the collimator 140. Since suitable materials and processes of the collimator 140 and the insulating layer 130 may be selected, the design described above may improve the adhesion between the collimator 140 and the insulating layer 130. Besides, the insulating layer 130 has a relatively flat surface, so the manufacturing process of the collimator may be more stable, that is, the stability of the collimator 140 in the display device 100 may be improved. In detail, the insulating layer 130 (e.g., including organic materials) may be disposed on the touch sensor 120 when the adhesion between the collimator 140 (e.g., including organic materials) and the touch sensor 120 (e.g., including inorganic materials or metal materials) is poor, and the stability of the element structure in the display device 100 may be improved due to the better adhesion between the collimator 140 and the insulating layer 130. Therefore, through the disposing and relative positional relationship of the touch sensor 120, the insulating layer 130 and the collimator 140 in the present disclosure, the collimator 140 having privacy function or controllable viewing angle function for adjusting the light emitting angle may be integrated in the display device 100 with touch function. When the display device 100 having the structure described above is applied to, for example, a vehicle display, the interference phenomenon of the light emitted by the display device 100 to the driver may be reduced (e.g., the light emitted by the display device 100 may be reflected by a windshield or a rear mirror to affect the driver's vision and cause driving safety problems), and the convenience or safety of the display device 100 may be improved.

Please refer to FIG. 1A and FIG. 1B. In the display device 100 of the first embodiment of the present disclosure, the insulating layer 130 covers the touch sensor 120, so that at least a portion of the touch sensor 120 is enclosed by the display layer 110 and the insulating layer 130 in the cross-sectional view schematic diagram along the cross line A-A′, and the insulating layer 130 has a substantially flat surface 130S. The collimator 140 is disposed on the surface 130S of the insulating layer 130, and the touch sensor 120 is substantially overlapped with the collimator 140 in the top view direction of the display device 100, wherein the top view direction is parallel to the normal direction V of the substrate 102. In some embodiments, the collimator 140 is correspondingly overlapped with at least a portion of the touch sensor 120 in the top view direction of the display device 100, such as correspondingly overlapped with the first mesh wire M1, but not limited herein. In detail, the collimator 140 includes at least one collimating unit CU, and the at least one collimating unit CU may respectively correspond to one of the plurality of first mesh wires M1 and extend along the first direction D1, so that the collimating unit CU may be overlapped with the first mesh wire M1 in the top view direction of the display device 100. The structure of the collimating unit CU may be, for example, a wall with a height, which may adjust the light emitted by the display device 100 to forward a direction or be within a range of an angle. In some embodiments, the collimator 140 is not overlapped with the light emitting unit LU in the top view direction of the display device 100, so as to reduce the influence on the brightness of the display device 100, but not limited herein.

Please refer to FIG. 1A. In some embodiments, the collimator 140 includes at least two collimating units CU arranged in a second pitch P2. The at least two collimating units CU may extend along the first direction D1 and respectively correspond to one of the plurality of first mesh wires M1. The second pitch P2 may be measured as the shortest distance from the center of one of the collimating units CU to the center of another adjacent collimating unit CU in the second direction D2, or the shortest distance from one side (e.g., the upper side) of one of the collimating units CU to the same side (e.g., the upper side) of another adjacent collimating unit CU, but not limited herein. Comparing FIG. 1A with FIG. 2, the second pitch P2 is less than the maximum length of the driving electrode 122 or the sensing electrode 124 in the direction X or the direction Y (not shown), and the first pitch P1 between adjacent sensing units SU is greater than the maximum length of the driving electrode 122 or the sensing electrode 124 in the direction X or the direction Y, so the second pitch P2 is less than the first pitch P1.

Please refer to FIG. 1B. In some embodiments, the maximum width of each first mesh wire M1 in the second direction D2 may be defined as a first width W1, the maximum width of each collimating unit CU in the second direction D2 may be defined as a second width W2, and the second width W2 is greater than the first width W1. The profile of the cross-sectional view of each collimating unit CU may be, for example, a shape with a gradually increasing width or a gradually decreasing width along the normal direction V of the substrate 102. For example, the profile of the cross-sectional view of each collimating unit CU is a trapezoid, but not limited herein.

In some embodiments, the collimator 140 includes one or a plurality of collimating units CU. The one or the plurality of collimating units CU respectively correspond to one of the plurality of first mesh wires M1 and extend along the first direction D1 and/or correspond to one of the plurality of second mesh wires M2 and extend along the second direction D2. That is to say, the number and extending direction of the collimating units CU may be adjusted according to practical requirements, so as to adjust the light emitting angle of the light emitted by the display device 100 to meet a determined direction or to be within a determined range of angle. In some embodiments, the display device 100 may further include a filling layer 150, and the filling layer 150 covers the collimator 140 and fills the gaps between the collimating units CU. The filling layer 150 and the insulating layer 130 may include the materials with the same or substantially similar refractive indices, but not limited herein.

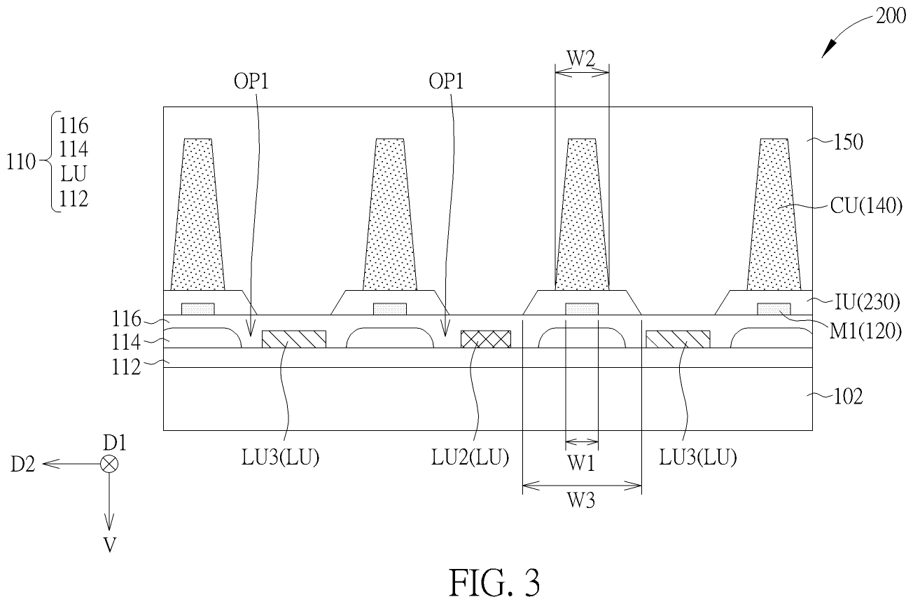

Please refer to FIG. 3. FIG. 3 is a cross-sectional view schematic diagram of a display device of a variation embodiment of the first embodiment according to the present disclosure. As shown in FIG. 3, in the display device 200 of this variation embodiment, the insulating layer 230 has openings which correspond to a portion of the light emitting units LU. In other words, the insulating layer 230 is not overlapped with the light emitting units LU in the top view direction of the display device 200. Furthermore, the collimator 140 is disposed on the insulating layer 230, and at least a portion of the insulating layer 230 is located between the collimator 140 and the touch sensor 120. In some embodiments, the touch sensor 120 is enclosed by the display layer 110 and the insulating layer 230 in the cross-sectional view. In detail, the insulating layer 230 includes at least one insulating unit IU, and the least one insulating unit IU may respectively correspond to one of the plurality of first mesh wires M1 and extend along the first direction D1. Each insulating unit IU is substantially overlapped with and covers the corresponding first mesh wire M1 in the touch sensor 120 in the normal direction V of the substrate 102 and directly contacts the display layer 110. For example, the insulating unit IU may be in contact with the protective layer 116 in the display layer 110. Therefore, the corresponding first mesh wire M1 is enclosed by the display layer 110 and each insulating unit IU in the cross-sectional view, and two adjacent insulating units IU may be separated from each other and expose the regions where a portion of the light emitting units LU are located. On the other hand, each collimating unit CU may correspond to one of the plurality of first mesh wires M1, extend along the first direction D1 and be disposed on the corresponding insulating unit IU, so that each collimating unit CU may be overlapped with the corresponding first mesh wire M1 and insulating unit IU in the top view direction of the display device 200. In some embodiments, each first mesh wire M1 has a first width W1 in the second direction D2, the maximum width of each collimating unit CU in the second direction D2 is be defined as a second width W2, and the maximum width of each insulating unit IU in the second direction D2 is defined as a third width W3. The third width W3 is greater than the second width W2, and the second width W2 is greater than the first width W1, that is, W3>W2>W1, but not limited herein. In the embodiment described above, the insulating unit IU, for example, has a strip shape corresponding to the collimating unit CU and covers at least a portion of the touch sensor 120, but not limited herein.

In other embodiments, the insulating layer 230 includes a plurality of openings and presents as a mesh-like pattern in the top view direction of the display device 200. The mesh-like insulating layer 230 may be disposed substantially corresponding to the mesh structure M of the touch sensor 120, and the width of the mesh-like insulating layer 230 in the first direction D1 or the second direction D2 is greater than the width of the corresponding first mesh wire M1 or second mesh wire M2 of the mesh structure M in the first direction D1 or the second direction D2. Furthermore, each opening of the insulating layer 230 may respectively correspond to one of the plurality of first openings OP1 of the pixel definition layer 114, so the mesh structure M of the touch sensor 120 is enclosed by the mesh-like insulating layer 230 and the display layer 110 in the cross-sectional view (i.e., the first mesh wire M1 and the second mesh wire M2 are enclosed). In addition, each collimating unit CU may respectively correspond to one of the plurality of first mesh wires M1, extend along the first direction D1 and be disposed on the insulating layer 230, so that each collimating unit CU is overlapped with the corresponding first mesh wire M1 and a portion of the insulating layer 230 in the top view direction of the display device 200. Through covering the mesh structure M of the touch sensor 120 by the mesh-like insulating layer 230, good protection may be provided for the touch sensor 120, but the present disclosure is not limited herein.

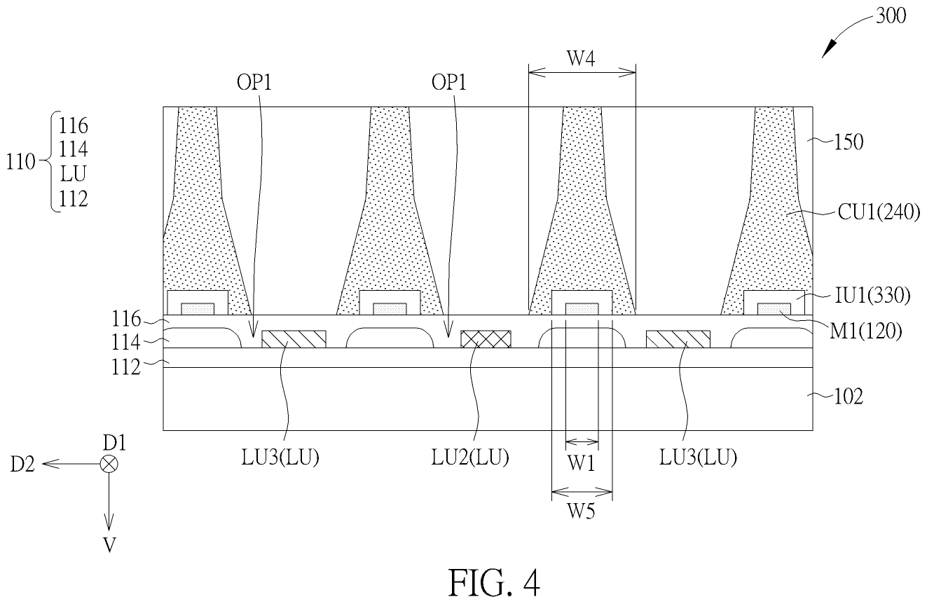

Please refer to FIG. 4. FIG. 4 is a cross-sectional view schematic diagram of a display device of another variation embodiment of the first embodiment according to the present disclosure. As shown in FIG. 4, in the display device 300 of this variation embodiment, the insulating layer 330 has openings which correspond to a portion of the light emitting units LU. In other words, the insulating layer 330 is not overlapped with the light emitting units LU in the top view direction of the display device 300. Furthermore, the touch sensor 120 is enclosed by the display layer 110 and the insulating layer 330 in the cross-sectional view, and at least a portion of the insulating layer 330 may be enclosed by the collimator 240 and the display layer 110. In detail, the insulating layer 330 includes at least one insulating unit IU1. The least one insulating unit IU1 may respectively correspond to one of the plurality of first mesh wires M1, extend along the first direction D1 and not be overlapped with the light emitting units LU in the top view direction of the display device 300, so the corresponding first mesh wire M1 of the touch sensor 120 is enclosed by the display layer 110 and each insulating unit IU1 in the cross-sectional view. Furthermore, the collimator 240 may include at least one collimating unit CU1, and the at least one collimating unit CU1 may respectively correspond to one of the plurality of first mesh wires M1, extend along the first direction D1 and cover the corresponding insulating unit IU1, so that each collimating unit CU may be overlapped with the corresponding first mesh wire M1 and insulating unit IU1 in the top view direction of the display device 300, and the corresponding insulating unit IU1 is enclosed by the collimating unit CU1 and the display layer 110. In some embodiments, the first mesh wire M1 has a first width W1 in the second direction D2, the maximum width of the collimating unit CU1 in the second direction D2 is be defined as a fourth width W4, and the maximum width of the insulating unit IU1 in the second direction D2 is defined as a fifth width W5. The fourth width W4 is greater than the fifth width W5, and the fifth width W5 is greater than the first width W1, that is, W4>W5>W1, but not limited herein. In the embodiment described above, the insulating unit IU1, for example, has a strip shape corresponding to the collimating unit CU1 and covers at least a portion of the touch sensor 120, but not limited herein.

In other embodiments, the insulating layer 330 includes a plurality of openings and presents as a mesh-like pattern in the top view direction of the display device 300. The mesh-like insulating layer 330 may disposed substantially corresponding to the mesh structure M of the touch sensor 120, and the width of the mesh-like insulating layer 330 in the first direction D1 or the second direction D2 is greater than the width of the corresponding first mesh wire M1 or second mesh wire M2 of the mesh structure M in the first direction D1 or the second direction D2. Each opening of the insulating layer 330 may respectively correspond to one of the plurality of first openings OP1 of the pixel definition layer 114, so the mesh structure M of the touch sensor 120 is enclosed by the mesh-like insulating layer 330 and the display layer 110 in the cross-sectional view (i.e., the first mesh wire M1 and the second mesh wire M2 are enclosed). In addition, each collimating unit CU1 may respectively correspond to one of the plurality of first mesh wires M1, extend along the first direction D1 and cover a corresponding portion of the insulating layer 330, so that each collimating unit CU1 is overlapped with the corresponding first mesh wire M1 and a portion of the insulating layer 330 in the top view direction of the display device 300, and the corresponding portion of the insulating layer 330 is enclosed by each collimating unit CU1 and the display layer 110. Through covering the mesh structure M of the touch sensor 120 by the mesh-like insulating layer 330, good protection may be provided for the touch sensor 120, but the present disclosure is not limited herein.

The display device of the present disclosure is not limited to the embodiments and variation embodiments described above, and other different embodiments or variation embodiments may exist. In order to simplify the illustration, the same components in the following embodiments would be labeled with the same symbol. Furthermore, for clearly showing the differences between various embodiments, the differences between different embodiments are described in detail below, and repeated features will not be described redundantly.

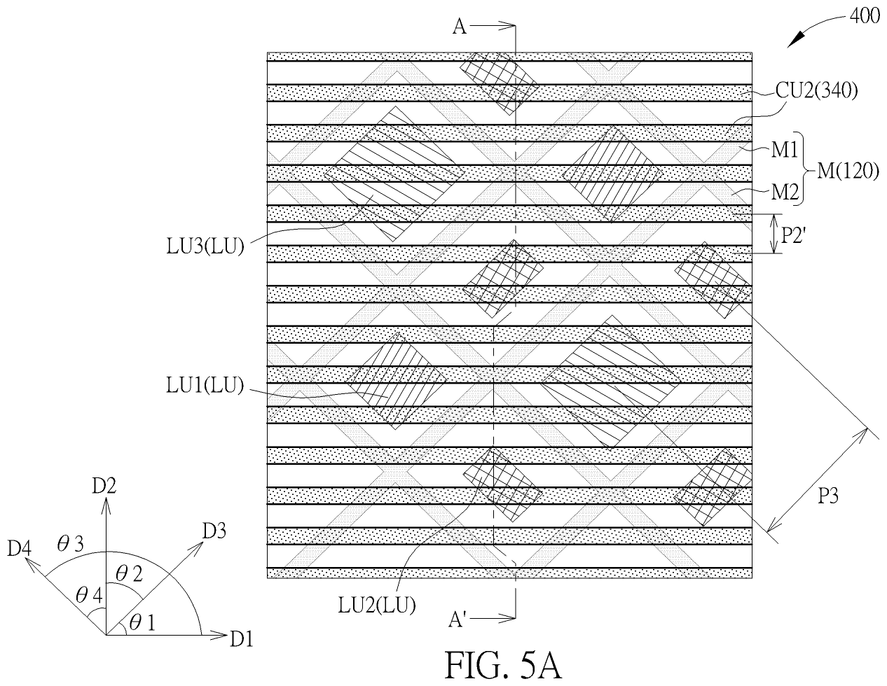

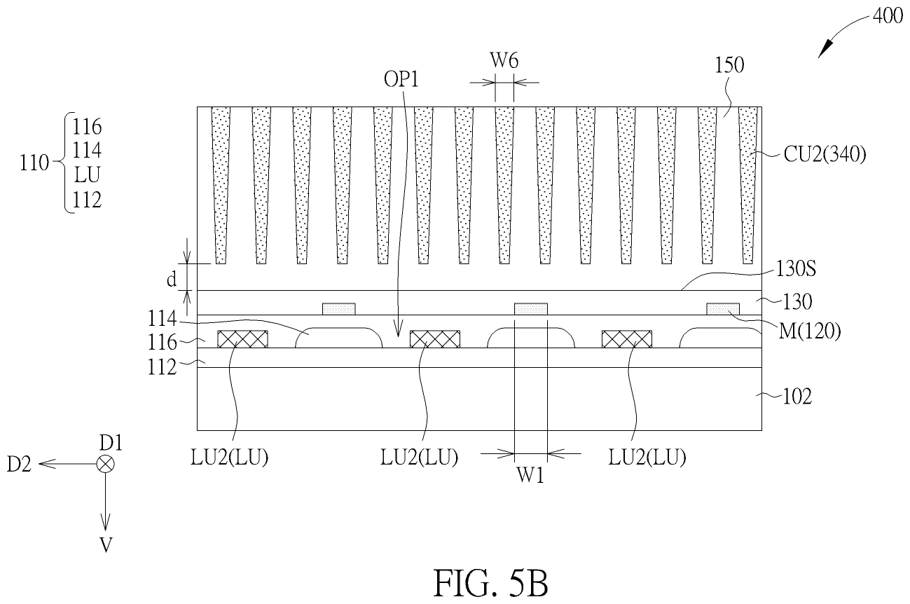

Please refer to FIG. 2, FIG. 5A and FIG. 5B. FIG. 5A is a partial top-view schematic diagram of a display device of a second embodiment according to the present disclosure. FIG. 5B is a cross-sectional view schematic diagram of the display device shown in FIG. 5A along the cross line A-A′. As shown in FIG. 5A and FIG. 5B, in the display device 400 of the second embodiment of the present disclosure, the collimator 340 is partially overlapped with the plurality of light emitting units LU and the mesh structure M of the touch sensor 120 (i.e., partially overlapped with the first mesh wires M1 and the second mesh wires M2) in the top view direction of the display device 400. In detail, in this embodiment, each first mesh wire M1 of the mesh structure M respectively extends along a third direction D3, and each second mesh wire M2 of the mesh structure M respectively extends along a fourth direction D4. The third direction D3 is not parallel to the fourth direction D4, such as that the third direction D3 may be substantially perpendicular to the fourth direction D4, but not limited herein. An included angle θ1 exists between the third direction D3 and the first direction D1, an included angle θ2 exists between the third direction D3 and the second direction D2, an included angle θ3 exists between the fourth direction D4 and the first direction D1, and an included angle θ4 exists between the fourth direction D4 and the second direction D2, wherein the angles of the included angle θ1, the included angle θ2, the included angle θ3 and the included angle θ4 may be greater than or equal to 0 degrees and less than or equal to 90 degrees, or greater than or equal to 90 degrees and less than or equal to 180 degrees. For example, as shown in FIG. 5A, the angles of the included angle θ1, the included angle θ2 and the included angle θ4 are respectively greater than 0 degrees and less than 90 degrees, and the angle of the included angle θ4 is greater than 90 degrees and less than 180 degrees, but not limited herein. Furthermore, the collimator 340 may include a plurality of collimating units CU2 extending along the first direction D1, and each collimating unit CU2 is partially overlapped with a plurality of light emitting units LU, the first mesh wires M1 and the second mesh wires M2 in the top view direction of the display device 400. In some embodiments, the collimator 340 includes at least two collimating units CU2 arranged in a second pitch P2′, and the display layer 110 includes at least two light emitting units LU arranged in a third pitch P3. The second pitch P2′ is less than the first pitch P1 between the adjacent sensing units SU described above, and the second pitch P2′ is less than the third pitch P3. Similar to the previous embodiments, the second pitch P2′ may be measured as the shortest distance from the center of one of the collimating units CU2 to the center of another adjacent collimating unit CU2 or from one side of one of the collimating units CU2 to the same side of another adjacent collimating unit CU2. Furthermore, the third pitch P3 may be measured as the shortest distance from the center of one of the light emitting units LU to the center of another adjacent light emitting unit LU, or the shortest distance from one side of one of the light emitting units LU (e.g., the lower left side of this light emitting unit LU) to the same side of another adjacent light emitting unit LU (e.g., the lower left side of this another light emitting unit LU). Therefore, the collimating units CU2 may be distributed in the display device 400 with a high density, so as to adjust the light emitting angle of the light emitted by the display device 400 to be within a range of an angle, that is, to reduce the range of viewing angle of the display device 400. In some embodiments, the maximum width of each collimating unit CU2 in the second direction D2 may be defined as a sixth width W6, and the sixth width W6 is less than the line width or the minimum width of each first mesh wire M1 and less than the line width or the minimum width of each second mesh wire M2. The profile of the cross-sectional view of each collimating unit CU2 may be, for example, a shape with a gradually increasing width or a gradually decreasing width in the normal direction V of the substrate 102. For example, the profile of the cross-sectional view of each collimating unit CU2 is a trapezoid, but not limited herein. In some embodiments, a gap d may exist between each collimating unit CU2 and the surface 130S of the insulating layer 130, but not limited herein.

Different from the previous embodiments, in this second embodiment, after the insulating layer 130 is formed, the collimator 340 is not formed, while the filling layer 150 is formed first, and then a mold-pressing process and a curing process may be applied to the filling layer 150 through a mold to create at least one trench in the filling layer 150. Then, the material (such as organic material) used to form the collimator 340 is filled into the trench of the filling layer 150, and the collimator 340 may be completed after the curing process, but not limited herein. The curing process may adopt heat curing or light curing, but not limited herein.

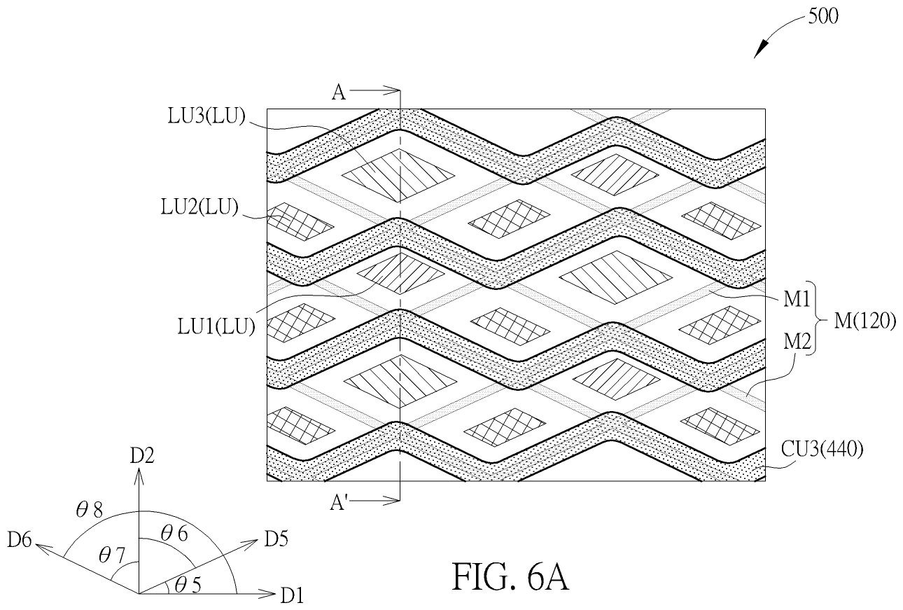

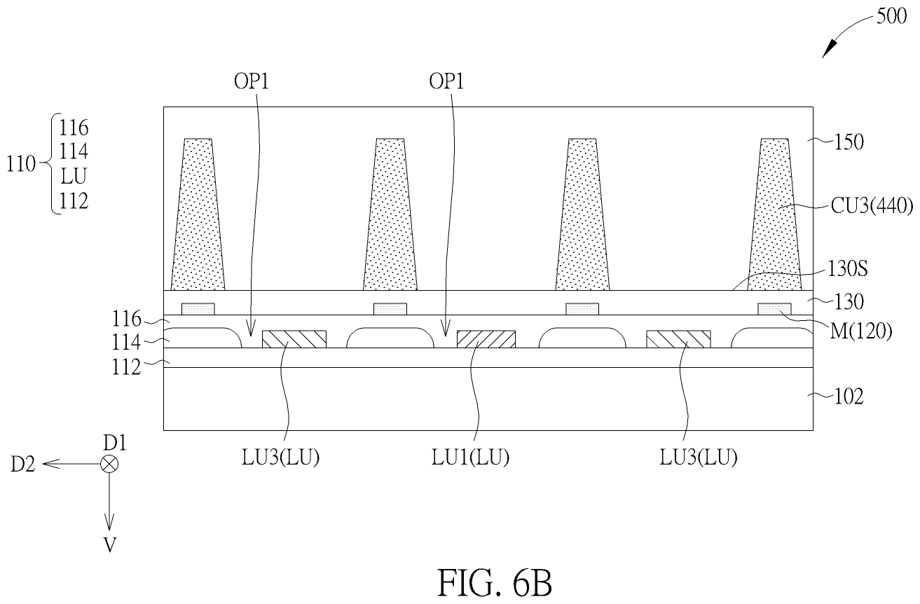

Please refer to FIG. 6A and FIG. 6B. FIG. 6A is a partial top-view schematic diagram of a display device of a third embodiment according to the present disclosure. FIG. 6B is a cross-sectional view schematic diagram of the display device shown in FIG. 6A along the cross line A-A′. As shown in FIG. 6A and FIG. 6B, in the display device 500 of the third embodiment of the present disclosure, the collimator 440 may be partially overlapped with the first mesh wires M1 and the second mesh wires M2 in the top view direction of the display device 500, and the collimator 440 may not be partially overlapped with the light emitting units LU in the top view direction of the display device 500. In detail, each first mesh wire M1 of the mesh structure M may respectively extend along a fifth direction D5, and each second mesh wire M2 of the mesh structure M may respectively extend along a sixth direction D6. The fifth direction D5 is different from the sixth direction D6, such as that the fifth direction D3 is not parallel to and not perpendicular to the sixth direction D6. An included angle θ5 exists between the fifth direction D5 and the first direction D1, an included angle θ6 exists between the fifth direction D5 and the second direction D2, an included angle θ7 exists between the sixth direction D6 and the first direction D1, and an included angle θ8 exists between the sixth direction D6 and the second direction D2, wherein the angles of the included angle θ5, the included angle θ6, the included angle θ7 and the included angle θ8 may be greater than or equal to 0 degrees and less than or equal to 90 degrees, or greater than or equal to 90 degrees and less than or equal to 180 degrees. For example, as shown in FIG. 6A, the angles of the included angle θ5, the included angle θ6 and the included angle θ8 are respectively greater than 0 degrees and less than 90 degrees, and the angle of the included angle θ7 is greater than 90 degrees and less than 180 degrees, but not limited herein. Furthermore, the collimator 440 includes at least one collimating unit CU3, and each collimating unit CU3 may be zigzag and substantially extend along the first direction D1. Each collimating unit CU3 may be partially overlapped with the first mesh wires M1 and the second mesh wires M2 in the top view direction of the display device 500, and the same one collimating unit CU3 may be overlapped with a portion among the plurality of first mesh wires M1 and the plurality of second mesh wires M2. Furthermore, each collimating unit CU3 may not be overlapped with the light emitting units LU in the top view direction of the display device 500. Therefore, the collimating units CU3 may adjust the light emitting angle of the light emitted by the display device 500 to be within a range of an angle.

From the above description, according to the display device of the embodiments of the present disclosure, through the disposing and relative positional relationship of the touch sensor, the insulating layer and the collimator, the display device may have privacy function or controllable viewing angle function and touch function. The privacy function, for example, provides display effects with a narrow range of viewing angle, thereby improving the convenience or safety of using the display device. In addition, by disposing the collimator to adjust or restrict the light emitting angle of the light emitted by the display device, the light emitting angle may be substantially concentrated in a range of an angle, so that the light emitted by the display device may have a narrow range of viewing angle. In addition, by disposing the collimator on the insulating layer, the collimator may have good adhesion, thereby improving the stability of the element structure in the display device.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A display device, comprising:
a display layer;
a touch sensor disposed on the display layer;
an insulating layer disposed on the touch sensor and the display layer; and
a collimator disposed on the insulating layer.

2. The display device according to claim 1, wherein the insulating layer is made of an organic material.

3. The display device according to claim 1, wherein at least a portion of the touch sensor is enclosed by the display layer and the insulating layer.

4. The display device according to claim 1, wherein the touch sensor is overlapped with the collimator in a top view direction of the display device.

5. The display device according to claim 1, wherein the touch sensor comprises at least two sensing units arranged in a first pitch, the collimator comprises at least two collimating units arranged in a second pitch, and the second pitch is less than the first pitch.

6. The display device according to claim 5, wherein the display layer comprises at least two light emitting units arranged in a third pitch, and the second pitch is less than the third pitch.

7. The display device according to claim 1, wherein the touch sensor comprises a driving electrode and a sensing electrode which is insulated from the driving electrode.
